(19) United States
(12) Patent Application Publication
(10) Pub. No.: US 2007/0278255 A1
(43) Pub. Date: Dec. 6, 2007

(54) CONDIMENT DISPENSER WITH COLLAPSIBLE SPOUT

(76) Inventor: Joseph A. Pantelleria, Overland Park, KS (US)

Correspondence Address: BLACKWELL SANDERS LLP, 4801 Main Street, Suite 1000, KANSAS CITY, MO, 64112, US

(21) Appl. No.: 11/420,835

(22) Filed: May 30, 2006

(51) Int. Cl. B67D 3/00; B65D 88/54

(52) U.S. Cl. 222/529; 222/327

(57) ABSTRACT

A condiment dispenser is provided for the dispensing of condiments such as ketchup, mustard and the like. The container includes a sidewall and two end closures. One of the end closures includes a dispensing spout attached to a resiliently flexible wall that is movable between extended and collapsed configurations to allow the spout to be recessed within the confines of the container for shipping and extended for dispensing. The container is adapted for being used and stored in an upside down condition wherein the spout is downwardly directed. The spout is configured to prevent leakage of the condiment therefrom during upside down storage.

### BACKGROUND OF THE INVENTION

Dispensers with spouts are well known. They are typically used to dispense such items as ketchup, mustard, mayonnaise, barbeque sauce, salad dressing and other thick liquids. They are often times used in the restaurant industry for the dispensing of condiments, e.g. mustard and ketchup, onto sandwiches. They may also be used to dispense salad dressing onto salads. Often times, these dispensers are used in the kitchen of a restaurant. In the kitchen, efficiency is very important both for speed of service and economy.

Refillable resiliently deformable dispensers have been known for a long time. These are often found on a table in a restaurant and sometimes in the restaurant's kitchen. Such a dispenser will include a deformable body with a storage chamber and a spout which is typically attached to the body through a screw on or snap lock connection. This provides for refilling of the body. However, refilling provides a possibility of contamination and tampering and takes time. Often times, it would be more cost effective to have a disposable dispenser that is pre-filled than it would be to provide a refillable container. However, dispensing containers using a spout usually have the spout permanently fixed in an extended position requiring additional packaging to effect shipping which packaging can be relatively expensive. It also then requires either a separator in the container to provide multiple layers of containers or the shipping of the containers in a one high configuration as opposed to a two or three high configuration. This results in additional packaging costs.

Containers with movable spouts are known. However, they do face certain disadvantages. One example of such a container is shown in U.S. Pat. No. 3,326,421. One of the problems with this container is that it requires a pressure differential to retain the spout in its collapsed configuration. U.S. Pat. No. 3,559,847 shows a collapsible container with a collapsible spout. The container is designed for the dispensing of a beverage permitting a person to drink directly from a container and is not adapted for dispending of a condiment by squeezing a sidewall of the container body. The configuration of the container requires squeezing of the container to extend the spout from its collapsed configuration and cannot contain its contents when inverted. The container of U.S. Pat. No. 3,831,824 has a spout that is insertable into the interior of the container. In use, both the interior and exterior of spout will be exposed to the contents of the container. Such would not be amendable for the dispensing of condiments since cleaning of the device would be required before use. U.S. Pat. No. 3,907,179 discloses a container with a dispensing spout which folds over from an upstanding position to a laying down position. This spout is not collapsible into the container and containers thus cannot be easily stacked one upon the other U.S. Pat. No. 4,997,112 discloses an adhesive container that uses a screw thread type mechanism to raise and lower the spout. The spout though is always in an extended position above the container body that has the storage chamber in it. U.S. Pat. No. 5,033,655 illustrates a container with an extendible spout. The spout automatically extends when a membrane is removed. It does not self lock in a collapsed configuration. U.S. Pat. No. 5,816,428 illustrates a beverage container that uses a metal sidewall can and has a collapsible spout attached to it. Such a container is not amendable for the dispensing of condiments because of the non-resiliently deformable sidewall provided by the metallic can.

There is thus a need for an improved condiment dispenser particularly adapted for use in restaurants.

### SUMMARY OF THE INVENTION

The present invention involves the provision of a dispensing container adapted to dispense condiments. The container includes a container body that has a storage chamber. The body has a resiliently flexible sidewall that permits its deformation and return to its pre-deformed condition. The sidewall has opposite ends, one of which is closed and the other of which is provided with a dispensing spout. The end with a dispensing spout has a transverse wall that is movable and selectively retainable in a collapsed configuration and an extended configuration. When in a collapsed configuration, the distal end of the spout is preferably flush to below flush with the end of the container and in the extended condition, the free end of the spout is extended beyond the free end of the sidewall. The transverse wall is resiliently retained in either its extended or collapsed configurations. The spout has a discharge passage that is configured to provide either neutral to negative capillary action between the flow passage wall and the condiment contained in the container. The end of the container with the spout is preferably configured for stacking when the spout is in the collapsed configuration. At least one of the container ends is formed separately from the sidewall and is attached to a sidewall after filling of the container with condiment.

The present invention also involves the provision of making a condiment dispenser. The method includes forming a sidewall and forming first and second closure members. One of the closure members has a wall portion with opposed first and second surfaces with the first surface having a substantial portion thereof convex and said second surface having a substantial portion thereof concave. The sidewall portion and at least one of the first and second closure members being joined together to define a storage chamber. A spout is formed to project from one of the first and second surfaces. The wall portion is resiliently movable between and resiliently retainable in first and second configurations wherein the wall provides an over center lock. The spout is movable in a direction generally parallel to the longitudinal axis of the container sidewall for movement between a collapsed configuration and an extended configuration. The distal end of the spout is approximately flush to below flush when the second closure member is in its collapsed configuration.

### BRIEF DESCRIPTION OF THE DRAWINGS

FIG. 1 is a perspective view of a condiment dispensing container shown with the dispensing spout in an extended configuration.

FIG. 2 is an enlarged fragmentary section view of the dispensing end of the container shown in FIG. 1.

FIG. 3 is a top plan view of the container of FIG. 1.

FIG. 4 is an enlarged fragmentary sectional view taken along the line 4-4 of FIG. 3 showing the dispensing spout in a collapsed configuration.

FIG. 5 is an enlarged side sectional view of the container of FIG. 1.

FIG. 6 is a view of two container ends showing the container ends nested with the spouts being in a collapsed configuration.

FIG. 7 illustrates an alternative embodiment of the present invention showing a different spout configuration.

FIG. 8 is a perspective view of the container shown in FIG. 7 but with the spout in a collapsed configuration.

FIG. 9 is a fragmentary perspective view of the container of FIG. 7 shown with the spout in a collapsed configuration and an overwrap membrane attached to the dispensing end of the container.

Like numbers throughout the various Figures designate like or similar parts and/or construction.

### DETAILED DESCRIPTION

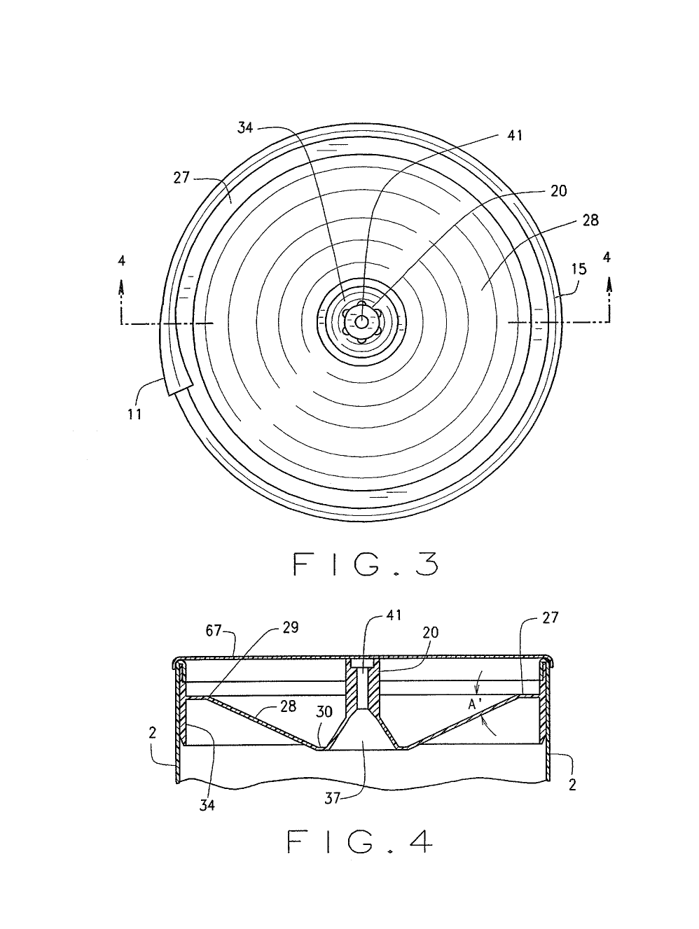

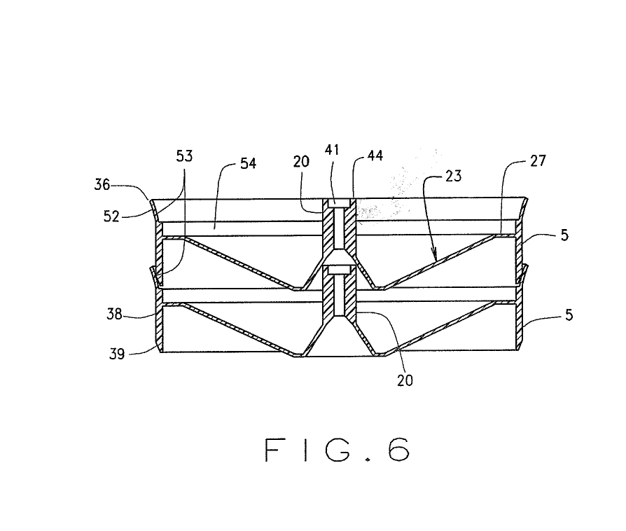

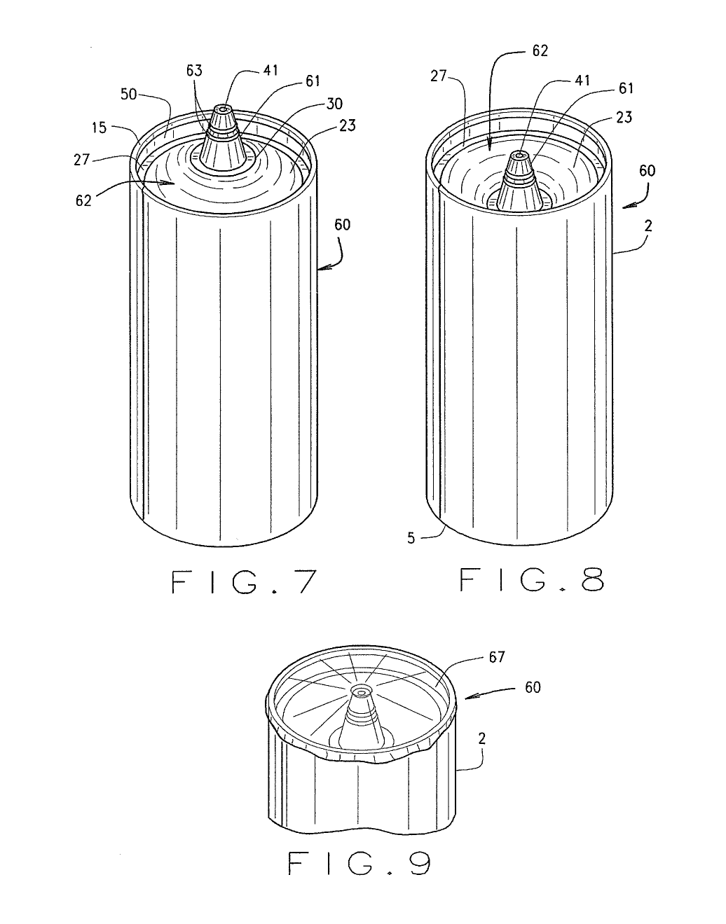

FIGS. 1-6 illustrate a first embodiment of the present invention. FIGS. 7-9 illustrate a second embodiment of the present invention differing from the first embodiment in the construction of the dispensing spout.

The reference numeral 1 designates generally a dispensing container having a sidewall 2 and opposite end wall closures 3 and 5. The walls 2, 3 and 5 define a storage chamber 6 adapted for storing condiment 7 or the like. In a preferred embodiment, the sidewall 2 is generally cylindrical both internally and externally however, it is to be understood that other cross sectional shapes can be utilized. The chamber 6 has a longitudinal axis 9 that is generally parallel to the external and internal surfaces of the sidewall 2. The sidewall 2 may be formed by extrusion, injection molding or may be convolutely wrapped and sealed to form an overlapping side seam 11. Preferably, the sidewall 2 is made of a polymeric material such as low or high density polyethylene or polypropylene having a thickness on the order of about 0.02 to about 0.05 inches to be self supporting. The material and thickness of the sidewall are such as to provide resilient deformability wherein once deformed, the material properties will return the sidewall 2 substantially to its pre-deformed shape. Alternatively, the walls 2, 5 may be integral and thin enough to be non-self supporting and in the form of a bag.

The closure 5 can be include a generally planar transversely extending wall 12 suitably attached to the sidewall 2 at one of the opposite ends 14, 15 of the sidewall 2. The closure 5 as shown, is formed separately from the sidewall 2 and is attached thereto as for example by rolling an end portion 17 inwardly and upwardly as seen in FIG. 5 to engage opposite sides of a skirt 18 depending from the panel 12. Attachment can be mechanical, adhesive, heat sealing or the like or combinations thereof. It is to be noted, that the sidewall 2 and the bottom closure 5 may be integrally formed as by injection molding, vacuum forming, blow molding or the like.

In a preferred embodiment, the end 14 has a configuration similar to the end 15 to permit stacking of one container 1 on top of another container 1. The transverse cross sectional shape of the container 1 is preferably round and the sidewall 2 is preferably generally cylindrical. Preferably, the closure 5 is molded of a polymeric material for example, low or high density polyethylene or polypropylene and can be formed as by thermoforming, injection molding or the like. Closure 5 is preferably resiliently deformable and has a thickness on the order of about 0.02 to about 0.05 inches.

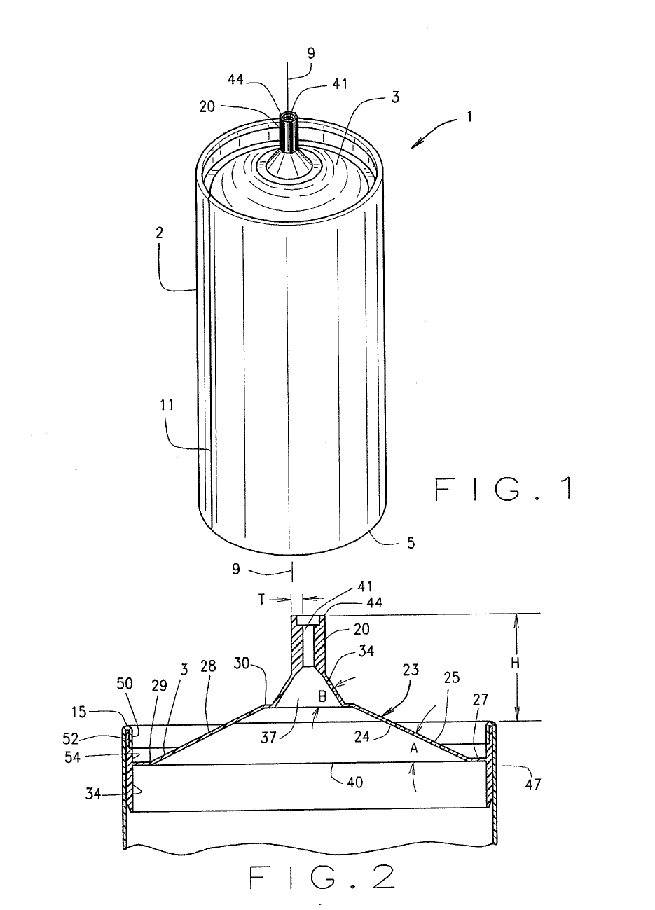

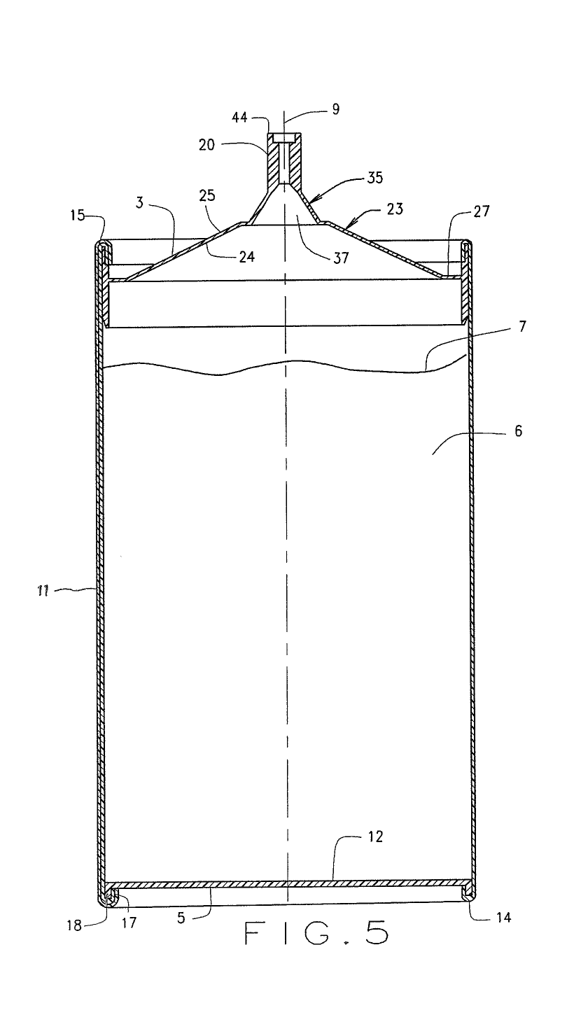

As best seen in FIGS. 2, 5, the container 1 includes a closure 3. The closure 3 has a dispensing spout 20. As shown, the closure 3 has a generally transverse wall 23 that is movable between an extended position, FIG. 5 and a collapsed position, FIG. 4. The inner and outer surfaces 24, 25 are generally concentric over a majority portion of the surface area of the wall 23. When the wall 23 is in the collapsed configuration, FIG. 4, the inside surface 24 is convex and the exterior surface 25 is concave. When the wall 23 is in its extended position, FIG. 2, the wall 24 is concave and the surface 25 is convex. An outer peripheral margin portion 27 is provided that is generally annular in shape when the transverse cross-section of the sidewall 2 is generally circular. By having the margin portion 27 generally planar, the principal flexing of the more central portion 28 of the wall 23 is between the zones 29 and 30 when the wall 23 is moved between extended and collapsed configurations. In operation, only one movement is needed, to move the spout 20 from collapsed to extended. The angle A (extended) and A′ (collapsed) as measured between a line generally tangent to the interior or exterior surface portion 24, 25 and the plane of the joinder of the wall 23 to the skirt 34 is preferably between about 20° and about 40°. It has been found that and angle A of approximately 30° works well providing both over center locking and adequate extension of the spout 20. In the illustrated structure, the closure 3 is provided with a wall portion 35 to join the spout 20 to the wall portion 28. The wall portion 35, as seen in FIGS. 2, 4, is generally frustoconical providing a pocket or recess 37 to help stacking or nesting of closures 3 both for storage, shipping and when the closures 5 are on a filling line to complete the container 1. The angle B of the wall 34 which is measured from a line generally tangential to the outer surface 34 and a line parallel to a plane defined by edge 40 is greater than the angle A and is preferably on the order of 45° to about 60°. The angle B is sufficiently different from the angles A, A′ to provide preferential deformation of the wall portion 28 over deformation of the wall portion 34 to effect extension and collapse of the wall 23.

The closure 3 is provided with the spout 20. The spout 20 as shown extends from the wall portion 34 and has a flow passage 41 generally centrally located within the spout 20. The cross sectional size and the length of the passage 41 are sufficient to provide neutral to negative capillary action between the surface defining the flow passage 41 and the condiment 7 contained within the container 1. It has been found that a generally cylindrical flow passage having a diameter in the range of between about 1/16 inch and 3/16 has been found acceptable for prevention of leakage and appropriate dispensing of condiment without the requirement of excessive force applied to the sidewall 2 to effect pressure on the condiment 7 in the chamber 6. The passage 41 is also configured to normally prevent discharge of the contents of the container 1 when it is stored in a spout down orientation without increasing pressure in the chamber 6. The passage 41 is shown as generally cylindrical but may be other shapes. At least a portion of the passage 41 is sized to provide neutral to negative capillary action between at least a portion of the interior of the spout 20 and the condiment. The spout 20 has a wall thickness T along a length L sufficient to prevent its collapse when gripped by a user who is moving the spout 20 from its collapsed configuration in FIG. 4 to its extended configuration as seen in FIG. 2. Pinching of the flow passage 41 can result in excessive pressure differential between the interior of the container 1 and the exterior to make movement between the extended and collapsed configurations difficult. The distal end 44 of the spout 20, when the spout 20 is in its extended position preferably is at an elevation H of at least about ½ inch to about 1½ inches and preferably about 1 inch above the free end 15 of the sidewall 2. In a preferred embodiment, the major cross sectional dimension of the sidewall 2 on the outside, is in the range of between about 2 inches and about 4 inches and preferably between about 2½ inches and about 3½ inches which would be the diameter in the event the sidewall 2 has a circular transverse cross sectional shape. The material chosen to make the closure 3 and the thickness of the wall section 28 is such as to provide a self sustaining or self supporting over center lock arrangement that will retain the wall member 23 either in its extended position or its collapsed configuration by the configuration of and material properties of the wall member 23. The thickness of the wall section 28 and the angle A and the material properties of the wall portion 28 are selected such that the force needed to move the spout 20 from its collapsed condition to its extended condition is in the range of between about 1 lb. and about 5 lbs. and preferably between about 2 lbs. and about 3 lbs. of force. This presents an acceptable range of gripping force required by user to grip the spout 20 to provide enough friction to effect the movement from the collapsed condition to the extended condition and to provide resilient self retention of the spout 20 in either its collapsed condition or its extended condition. Movement of the spout 20 is in a direction that is generally parallel to the longitudinal axis 9. Preferably, the longitudinal axis of the spout 20 and the longitudinal axis 9 are coaxial. Preferably, the spout 20 is valveless and is movable manually by a user.

In the illustrated structure, the closure 3 is formed as a part separate from the sidewall 2. It can be formed for example by injection molding and is preferably of a polymeric material for example low or high density polyethylene or polypropylene. As seen, the closure 5 has a skirt 34 that has a portion extending above and below the margin portion 27. The exterior 38 of the skirt 34 is sized and shaped to fit snuggly within the sidewall 2 and to be secured thereto. Any suitable form of securement can be used, e.g., adhesive bonding, heat sealing or the like. An outward extending annular flare 36 may be provided to ensure a snug fit between the skirt 34 and the interior surface of the sidewall 2. A tapered lead in 39 may also be provided. It is to be noted too, that the closure 3 may be molded as an integral part of the sidewall 2. It is preferred that when the closure 3 is formed, it is formed with the wall portion 23 being in the collapsed condition. Preferably, one or the other of the closures 3, 5 is formed as a separate part to allow for ease of depositing the condiment 7 into the chamber 6 for filling. In the illustrated structure, the closure 3 is secured to the sidewall 2 by folding the upper portion of the sidewall 2 over at 15 to form a reverse bend and securing the upper margin portion 50 to an upper portion 52 of the skirt 34. As seen, a groove 53 can be provided in the upper portion 52 of the skirt 34 to provide a generally flush fit of the exterior surface of the portion 50 with the surface 54.

FIGS. 7, 8 and 9 illustrate a second embodiment of the present invention. The reference numerals used to described the embodiment shown in FIGS. 1-6 are utilized in FIGS. 7-9 where the parts are similar or the same. The principle difference between the container 1 and container 60 is the spout 61 of end closure 62. The spout 61 in FIGS. 7-9 is generally frustoconical on the exterior having at least one outwardly projecting reinforcing rib 63 on the exterior surface. The rib or ribs 63 can provide both assistance in moving the spout 61 from a collapsed configuration, FIG. 9, to the extended configuration, FIG. 7. The interior shape of the spout 61 can be similar to the exterior shape of the spout 61 to provide room for stacking of containers 60 or end closures 62.

As seen in FIG. 9, the container 60 may be provided with a secondary membrane closure 67 to extend over the closure 5 to provide tamper evidence and sealing of the contents of the container 60. The closure 67 may be clear polymeric material for example a heat shrinkable polymer and may be heat sealed or adhesively secured to the upper end of the container 1. The membrane closure 67 as shown in FIG. 9 as being secured to the container 60 but it is to be understood that it may also be secured similarly to the container 1. The closure 67 may engage the free end of the spout 20 or 61 to seal the flow passage in which event, the spout free end 44 is preferably slightly above flush.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations, and other uses and applications of the present construction will, however, become apparent to those skilled in the art after considering the specification and the accompanying drawings.

1. A dispensing container comprising;
A container body defining a storage chamber with first and second opposite ends, said body having a sidewall portion and a first closure member adjacent said first opposite end and a second closure member adjacent the second opposite end, said second closure member including a wall and a spout extending outwardly of the wall, said wall being resiliently movable between a recessed position and an extended position and being sized and shaped to selectively retain said wall in its recessed or extended position, said spout being attached to and movable in a direction generally parallel to a longitudinal axis of the spout with the wall and having a free end, said free end being approximately flush to below flush with the second end when the wall is in the recessed position and above flush when the wall is in the extended position, said spout having a flow passage to provide flow communication between the chamber and an exterior of the container body.

2. The container as set forth in claim 1 wherein the wall has an interior surface and an exterior surface, at least a majority of the interior surface being convex when the wall is recessed and concave when the wall is extended.

3. The container as set forth in claim 2 wherein the at least a majority of the exterior surface being generally concave when the wall is recessed and generally convex when the wall is extended.

4. The container as set forth in claim 3 wherein the wall being configured to provide an over center lock to resiliently maintain the wall in the extended and recessed positions.

5. The container as set forth in claim 4 wherein the spout has sufficient rigidity to substantially prevent collapse of the flow passage during movement of the wall from the recessed position to the extended position.

6. The container as set forth in claim 1 including condiment in the chamber.

7. The container as set forth in claim 6 including a seal member restricting access to the chamber through the flow passage.

8. The container as set forth in claim 7 wherein the seal member including a membrane secured to the container body in overlying relationship to the spout and wall with the wall in the recessed position.

9. The container as set forth in claim 6 wherein at least a portion of the flow passage being sized to prevent free flow of the condiment out of the spout when the spout is directed downwardly.

10. The container as set forth in claim 6 wherein spout has sufficient rigidity to resist substantial reduction in the cross sectional area of the flow passage during movement of the wall from the recessed position to the extended position.

11. The container of claim 1 wherein the sidewall portion having a side seam.

12. The container of claim 11 wherein the first and second closure members being bonded to the sidewall portion.

13. The container of claim 1 wherein the sidewall portion being molded to shape.

14. The container of claim 13 wherein at least one of the first and second closure members being molded and integral with the sidewall portion and the other of the first and second closure members being bonded to the sidewall portion.

15. The container as set forth in claim 6 wherein the flow passage being sized and shaped to provide negative or neutral capillary action with the condiment when the container is positioned with the spout pointing generally downwardly.

16. A method of making a dispensing container, said method including;
forming a sidewall portion;
forming a first closure member;
forming a second closure member having a wall portion with opposed first and second surfaces with said first surface having a substantial portion thereof convex and said second surface having a substantial portion thereof concave, wherein the sidewall portion and at least one of the first and second closure members being joined together to define a storage chamber forming a spout projecting from one of the first and second surfaces, and wherein the wall portion being resiliently movable between and resiliently retainable in first and second configurations wherein the wall portion provides an over center lock.

17. The method of claim 16 including placing condiment in the storage chamber.

18. The method of claim 17 including attaching one of the first and second closure members to the sidewall portion after condiment is placed in the storage chamber and attaching the other of the first and second closure members to the sidewall portion before placing condiment in the storage chamber.

19. The method of claim 18 including storing the container and condiment with the wall member and spout being in a recessed position.

20. The method of claim 19 including moving the wall member and spout to an extended position and thereafter dispensing condiment.
